SEQUENCE LISTING (4 sequences)

SEQ ID NO: 1 - DNA, 19 bp, Artificial sequence
  PCR forward primer
tctgcgagaagtccattga

SEQ ID NO: 2 - DNA, 19 bp, Artificial sequence
  PCR reverse primer
tactaggggaatcctcgta

SEQ ID NO: 3 - DNA, 20 bp, Artificial sequence
  PCR forward primer
aaggatcattgtcgaaacct

SEQ ID NO: 4 - DNA, 20 bp, Artificial sequence
  PCR reverse primer
tcgacacgcattgtttaaga

(19) United States
(12) Patent Application Publication
(10) Pub. No.: US 2011/0071112 A1
(43) Pub. Date: Mar. 24, 2011

(54) Compositions and Methods for Preserving Colors and Patterns of Plants

(75) Inventors: Chia-Wei Li, Hsinchu (TW); Zi-Shun Hung, Hsinchu (TW); Chi-Chang Lin, Hsinchu (TW)

(73) Assignee: NATIONAL TSING HUA UNIVERSITY, HSINCHU (TW)

(21) Appl. No.: 12/889,324

(22) Filed: Sep. 23, 2010

(30) Foreign Application Priority Data
Sep. 23, 2009 (TW) 098132155

(51) Int. Cl. A01N 55/08; A01P 15/00

(52) U.S. Cl. 514/64

(57) ABSTRACT

The present invention relates to a composition for preserving plants, which comprises 5 carbon alcohol, at least one alcohol selected from the group consisting of 3 carbon alcohol and 4 carbon alcohol, a thiourea and at least one acid selected from the group consisting of tartaric acid and boric acid. The composition is used to preserve colors, patterns and DNA of plants. The composition can also be used to change colors of flowers. The present invention also relates to a method for preserving plants, which comprises soaking the plants in the composition of the present invention.

### FIELD OF THE INVENTION

The present invention relates to a composition and method for preserving colors, patterns and DNA of plants. The composition can also be used to change colors of flowers. The present invention also relates to a method for preserving plants, which comprises soaking the plants in the composition of the present invention.

### BACKGROUND OF THE INVENTION

There has long been an interest in preserving and displaying specimens of various kinds. It is frequently desirable to preserve and display specimens for decorative purposes such as flower buds or blossoms, particularly those that have sentimental value such as from wedding bouquets and other special occasions.

Antimicrobial and antiseptics was concerned in the early stage of the study of plant conservation. However, the preservation of the natural colors of plants did not get much attention at that time. Although traditional plant preservation methods (e.g. soaking in formalin or in high percentage alcohol) can effectively preserved the configuration of specimens, losses of hues is an unsolved problem.

One of the most common ways to preserve specimens in the museums is simply to storage the specimen in a preserving solution or liquid such as high concentrations of alcohol, formalin or glutaraldehyde. Such prior art processes are not, however, entirely satisfactory because the delicate natural colors of the flowers tend to fade relatively quickly and the DNA of the specimens is seriously damaged so that special storage techniques are necessary.

It has been well known that the plant pigments, such as carotene and chlorophyll, are relatively easy to be preserved, while the preserving effect remains unsatisfied for the plants containing lots of anthocyanin. Anthocyanin is the main color presenting pigment for most of the flowers, and keeping the anthocyanin is the key point to maintain the color of flowers. However, it is hard to preserve anthocyanin since these kinds of water-soluble molecular are unstable.

Anthocyanin is the main composition for colorful plants. They are water-soluble vacuolar pigments that may appear red, purple, or blue according to pH.

Anthocyanin occurs in all tissues of higher plants, including leaves, stems roots, flowers and fruits. They are very unstable and susceptible to external environmental factor such as temperature, light, pH value and other substances such as oxides. Consequently, there have not been available methods for long-term preservation as to the research of plant specimen's color preservation. The characteristics of anthocyanin are briefly as follows:

### (A) Structure

The structural differences of anthocyanin caused by its different sugars and organic acids substituent affect its activity and stability. The increase of sugars substituent of the glycosides stabilizes anthocyanin, for instance, delphinidin is more stable than cyaniding when it is in acidic methanol. The increase of methoxy substituted on the hydroxyl group decrease the stability of anthocyanin, for instance, the stability of cytochrome with methoxyl substituted at C-4′ and C-7′ is lower than that of chtochromes with hydroxyl group at the same position. The structural difference of anthocyanin affects not only its stability but also the color of flowers. The increase of hydroxyl makes the color of flowers change gradually from pink to blue, while the increase of methoxyl results in the opposite trend. In addition, the amount of sugar substituent on anthocyanin was proved to stabilized it, for example, cyaniding is more stable than malvidin but less stable than malvidin-3-glucoside.

### (B) Concentration

An increase in the concentration of anthocyanin enhances their stability. For instance, raising the cyanin concentration from 10-4 to 10-2 increases the color intensity 300 folds. The increase of color intensity is mainly through the raised stability of anthocyanin caused by its self-binding effect.

### (C) pH Value

The color of anthocyanin depends on the pH value of the solution. The primary structures of anthocyanin in acidic environment are 2-phenylbenzopyrylium (also called flavylium) cation, quinonoidalbase, carbinol pseudobase and chalcone (Maarit Rein, 2005. Copigmentation reactions and color stability of berry anthocyanin, Academic Dissertation). When pH=1, red 2 phenyl benzo a pyrylium cation is the major component; in the range from pH=2 to pH=4, quinonoidalbase is the major component; in the range from pH=5 to pH=6, colorless carbinol pseudobase and light yellow chalcone are the major components. Under the range from pH=8 to pH=9, some anthocyanin were confirmed to increase the stability of pigment but not the color intensity (Torgils Fossen, Luis Cabrita & éyvind M. Andersen. Colour and stability of pure anthocyanin. Food Chemistry, Vol. 63, No. 4, pp. 435±440, 1998). The color rendering of anthocyanin is affected by the different ratio of the four main ingredients under different pH values mentioned above. When the pH value is low, red 2-phenylbenzopyrylium cation (AH+) is the major component; however, when the pH value increases, the 2 phenyl benzo a pyrylium cation becomes others 2 kinds of structures and causes the loss of color. When pH>7, anthocyanin are very unstable and easily decomposed. Therefore, the pH value influences the color rendering of anthocyanin very much.

### (D) Temperature

The degradation rate of anthocyanin increases when the temperature of solutions or environments conserving it increases. When the pH value stays from 2 to 4, the increase of temperature makes the sugar substituted of anthocyanin be broken, results in the degradation of anthocyanin and unstable structures and produces brown products. This degradation becomes more obvious when oxygen exists. The effects of temperature to the increase anthocyanin's degradation rates are reduced when decreasing pH value and removing oxygen.

### (E) Enzyme

Studies have indicated that in plants there are several kinds of enzymes make anthocyanin degrade. Those enzymes include: glycosidases, peroxidases and phenolases. Glycosidases brake down the covalent bond between the sugar-base and glycosides, produce unstable structures and lead to the degradation of anthocyanin.

(F) Other factors

Light affects the degradation rate of anthocyanin by its two characteristics. Light itself plays an indispensable role in the process of anthocyanin biosynthesis, and it also increases degradation rate of anthocyanin. Another characteristic of light is that the resulted heat from illumination increases the temperature and cause anthocyanin degradation. In addition of these reasons mentioned above, the presence of oxygen had been proven to enlarge other factors' effect to degradation rate of anthocyanin.

Copigmentation is a solution phenomenon that pigments and other organic molecular or metal ion form complexes. The material participate in the copigmentation is called copigment. The color of anthocyanin can be stabilized and enhanced by copigmentation reactions (A. J. Davies and G Mama. Copigmentation of Simple and Acylated Anthocyanin with Colorless. J. Agric. Food Chem. 1993, 41, 716-720). Four kinds of copigmentation include: self-association, intermolecular copigmentation, intramolecular copigmentation and metal complexation.

The copigmentation leads to the bathochromic shift in the anthocyanin solution. Bathochromic shift is a change of spectral band position in the absorption, reglectance, transmittance or emission spectrum of a molecule to a longer wavelength (lower frequency). The copigmentation can change the present color from red to near blue. Beside, the hyperchromic effect is also discovered in the copigmentation of anthocyanin. Hyperchromic effect increases the color intensity of anthocyanin. Copigmentation is of critical importance in understanding the relationship between grape composition and wine color, the variation in color and pigment concentration between wines, and in all reactions involving the anthocyanin during wine aging.

Copigments are usually colorless or only very slightly, mainly yellowish compound occurring naturally in plant kingdom in cells alongside anthocyanin. A wide range of different molecules has been found to act as copigments. The most common copigment compounds are flavonoids, alkaloids, amino acids, organic acids, nuclei acid polyphenols, metal ions or other anthocyanin. The structures of anthocyanin contain abundant π-electrons systems and are easily to bind with 2-phenylbenzopyrylium cation (AH+). This binding prevents the 2-position of flavylium cation from nucleophilic attack of water or the 4-position of flavylium cation from attack of peroxides and sulfur dioxide. The characteristic of copigments stabilize the structure and decrease the degradation rate of anthocyanin (Maarit Rein, 2005. Copigmentation reactions and color stability of berry anthocyanin. Academic Dissertation). Hydrogen bonding and hydrophobic interactions have been suggested as the main mechanistic driving forces for intermolecular copigmentation, and all main kinds of anthocyanin show this phenomenon. Intermolecular interactions can occur with both the flavylium cation and the quinonoidal base forms of the anthocyanin. Since both these colored equilibrium forms of anthocyanin are almost planar, with efficiently delocalized π-electrons, the interactions with copigments, having the same structural features, make the interactions between the flavylium cation or quinonoidal base and copigment much more easier and probable. This results in an overlapping arrangement of the two molecules, preventing nucleophilic attack of water on the anthocyanin molecule. The formation of hydrogen bonds between the keto group of the quinoidal base form of an anthocyanin and a flavonol copigment has been suggested as a possible means of complex formation. In such a case, the keto group in the 7- or 4′-position of the anthocyanin would hydrogen bond with the 7-, 3′, or 4′-hydroxyl group of a flavonol. The aromatic residues of acyl groups of an anthocyanin interact with the positively charged flavylium cation so that the reactivity of the carbon C-2 and C-4 with nucleophilic reactants, e.g. water molecules, is hindered. The number of acyl groups, their structure, and the position of attachment to glycosyl residues, as well as the structure and number of saccharides affect the intramolecular copigmentation.

The mechanism of self-association has been discussed to be analogous to the stacking-like interactions. Self-associations of anthocyanin have been observed to take place during wine aging and it is assumed that they may partially contribute to the color of aged wines.

Many variations of flower colors were originally explained to be due to complex formation between blue metal chelates with red flavylium salts. The most common metals in anthocyanin complexes are tin (Sn), copper (Cu), iron (Fe), aluminum (Al), magnesium (Mg), and potassium (K). Only cyanidin, delphinidin and petunidin based anthocyanin, which have more than one free hydroxyl group in the B-ring, are capable of metal chelation. Recent studies have indicated that when pH=5, the combination of O-2-hydroxy anthocyanin and Fe (III) or Mg (II) is essential for plants to exhibit the blue color (Kumi Yoshida, Sayoko Kitahara, Daisuke Ito, Tadao Kondo. Ferric ions involved in the flower color development of the Himalayan blue poppy, Meconopsis grandis. Phytochemistry 67 (2006) 992-998).

There are many traditional preserving methods, such as soaking, low temperature vacuum dry, cutting absorption method. The soaking method usually uses 5% formaldehyde or 70% alcohol as specimen soaking solution to preserve the pattern or figure of specimen. Although this method is easy to achieve, the biggest drawback is that the original color of plant can not be preserved. The main traditional soaking preserving methods are as follows:

### (1) Green Specimen Preservation:

After cleaning and disinfection, soak the green leaves or fruit in acid solution under high temperature. The acid solutions include acetic acid. The magnesium ions in porphylin of chlorophyll can be replaced by H+-Cu2+-Zn2+.H+ is easier to get into chlorophyll to replace magnesium and form pheophytin when the samples are treated with acid solution. The pheophytin bind with Cu2+ to form copper chlorophyll, which has more stable colors to achieve the aim of color preservation. Immerse the sample in acidic glycerol solution after Cu2+ replacement. The glycerol solutions include Glycerol sulfite solution (Huang Zhao-yu ,Jiang Bo, Qin Xue-mei. Studying on Keeping Color of Color primaries in Plant Specimen. Journal of Yulin Teacgers College. Vol. 27, NO. 3, 126-128).

### (2) Yellow Flower and Fruit Preservation:

This kind of methods is developed for the preservation of carotene and lutein. The method can be divided into the front steps and liquid preservation. The front step is to soak the flower and fruit samples in low concentration of copper sulfate solution for several hours. Samples after soaking are preserved in low concentration of sulfite solution.

At present, the green and some yellow plant preservation method is one of the more successful preservation methods because coloring pigments of such plants are carotenoid or lutein which is more stable. The preservation method for plants taking anthocyanin as their main coloring pigments needs further investigation. U.S. Pat. No. 4,272,571 and No. 5,227,205 provide methods for preserving colors and patterns of plants. However, the inventor of the present invention found that those methods could not achieve good preservation efficiency after actual implementation. U.S. Pat. No. 4,272,571 uses tert-butanol to dehydrate, however, the method of dehydration changes some plants' color. For instance, experiments confirmed that the formula changes the color of roses from bright red to purple. The method that U.S. Pat. No. 5,227,205 provides is too complicated and has too many factors which may affect the result.

### SUMMARY OF THE INVENTION

The present invention relates to a composition for preserving colors, patterns and DNA of plants. The composition can also be used to change colors of flowers. The present invention also relates to a method for preserving plants, which comprises soaking the plants in the composition of the present invention.

### BRIEF DESCRIPTION OF THE DRAWINGS

FIG. 1 shows flowers soaked in the preserving solution containing 0.75% boric acid.

FIG. 2 shows the preserving effect of the preserving solution containing boric acid and tartaric acid (from the left first to third were boric acid 0.5%+tartaric acid 0.05%, boric acid 0.25%+tartaric acid 0.01%, and the preserving solution without acid; the right first was the specimen soaked in the original preserving solution).

FIG. 3 shows flowers of compositae soaked in the mix preserving solution.

FIG. 4 shows fresh dendrobium sonia flower.

FIG. 5 shows the comparison of dendrobium sonia flower soaked in water (left figure) and preserving solution (right figure) for 1 day, respectively.

FIG. 6 shows the (left figure) and 28 days (right figure).

FIG. 7 shows the dendrobium sonia flower soaked in preserving solution for 50 days.

FIG. 8 shows flowers stored in room temperature (upper figure) and soaked in water (lower figure) for 7 days.

FIG. 9 shows comparison of fresh dendrobium sonia flower (upper figure) and flower under 6 month strong illumination (lower figure). The white arrow indicates the original purple portion; the black arrow indicates the original dark purple portion.

FIG. 10 shows the spectrum detected by spectrometer under two kinds of pH value (light color: pH=1, dark color: pH=4.5).

FIG. 11 shows the changing of the amount of anthocyanin in dendrobium sonia specimens.

FIG. 12 shows HPLC spectrum analysis (530 nm) for anthocyanin in dendrobium sonia specimen.

FIG. 13 shows the result of electrophoresis for dendrobium sonia naked DNA which soaked in preserving solution (M: mark, F: fresh dendrobium sonia naked DNA, 1 w: sample soaked for 1 week, 2 w: sample soaked for 2 weeks, 1 m: sample soaked for 1 month, 2 m: sample soaked for 2 months).

FIG. 14 shows the changing of DNA concentration of dendrobium sonia. (ng/μl)

FIG. 15 shows preserving effect of genome DNA at different time point (M: mark, F: fresh dendrobium sonia DNA extracts, 1 d: sample soaked for 1 day, 1 w: sample soaked for 1 week, 1 m: sample soaked for 1 month, 2 m: sample soaked for 2 months, 3 m: sample soaked for 3 months).

FIG. 16 shows the result of electrophoresis of PCR (M: mark, 1 d: sample soaked for 1 day, 1 w: sample soaked for 1 week, 2 m: sample soaked for 2 months, 3 m: sample soaked for 3 months).

FIG. 17 shows the stem of fresh grand gala soaked in the rose preserving solution.

FIG. 18 shows the completed specimens soaked in rose preserving solution.

FIG. 19 shows the comparison of fresh rose (right) and rose soaked in the preserving solution for at least 6 months (left).

FIG. 20 shows the comparison of rose soaked in the preserving solution (right) and soaked in water for at least 2 weeks (left).

FIG. 21 shows the preserving effect of rose soaked in the preserving solution for at least 6 months under dark (left) and illumination (right), respectively.

FIG. 22 shows HPLC spectrum analysis of standard sample (A) and anthocyanin extracted from sample soaked in the preserving solution for 12 weeks (B):

FIG. 23 shows spectrum of rose pigments detected by spectrometer under two kinds of pH values.

FIG. 24 shows the amount of anthocyanin of three sets of rose sample.

FIG. 25 shows the trend of variation by the time for the amount of anthocyanin of 3 sets of rose sample.

FIG. 26 shows the extraction of genome DNA of leaf soaked in the preserving solution. (M: 1 kb mark)

FIG. 27 shows the PCR results of leaf genome DNA extracted at different time points. (M: 1 kb mark)

FIG. 28 shows the preserving effect of rose DNA soaked in different kinds of preserving solution (M: 1 kb mark, C: extracted·genome DNA directly observed by electrophoresis).

FIG. 29 shows the preserving effect naked DNA soaked in the preserving solution without tartaric acid (M: 1 Kb mark, C: DNA dissolved in TE buffer).

FIG. 30 shows the result of direct electrophoresis (left figure) and gene amplification by PCR (right figure) of leaf genome DNA soaked in two kinds of preserving solution (M: 1 Kb mark, no acid: preserving solution without tartaric acid, T: rose preserving solution).

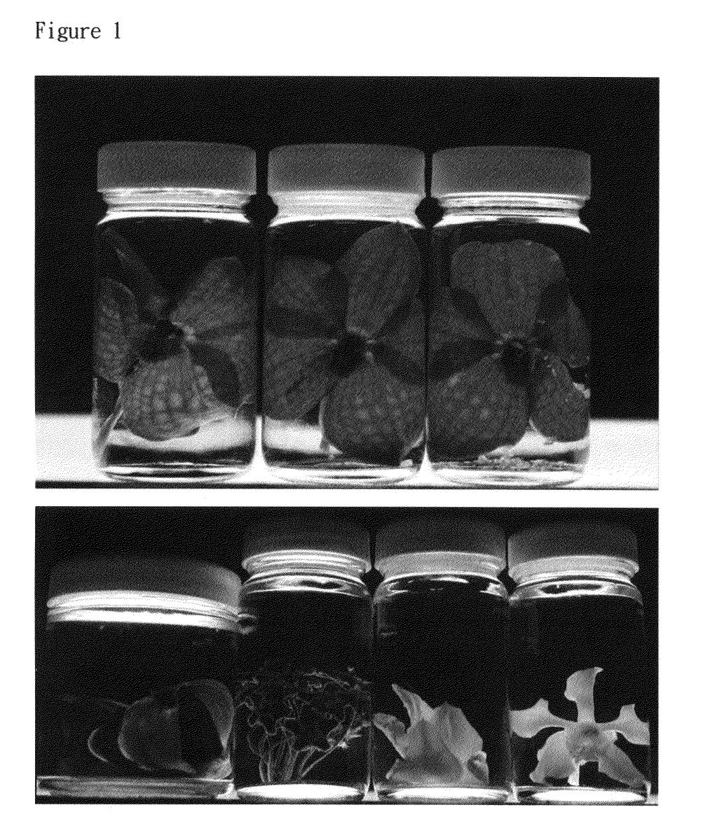

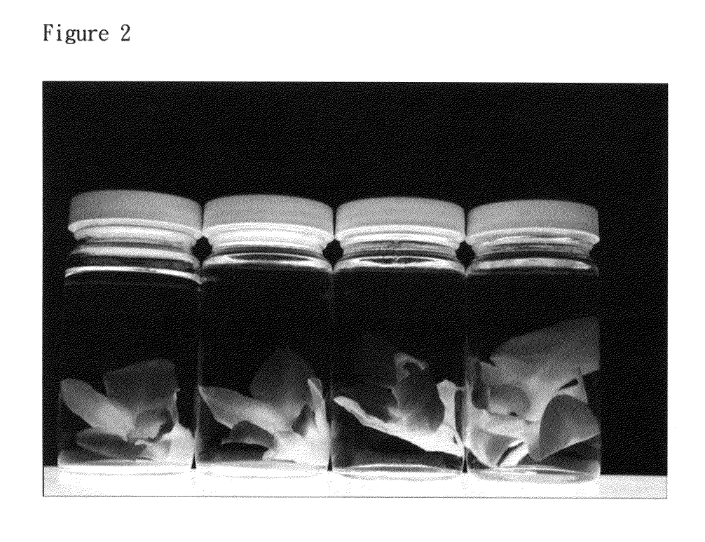

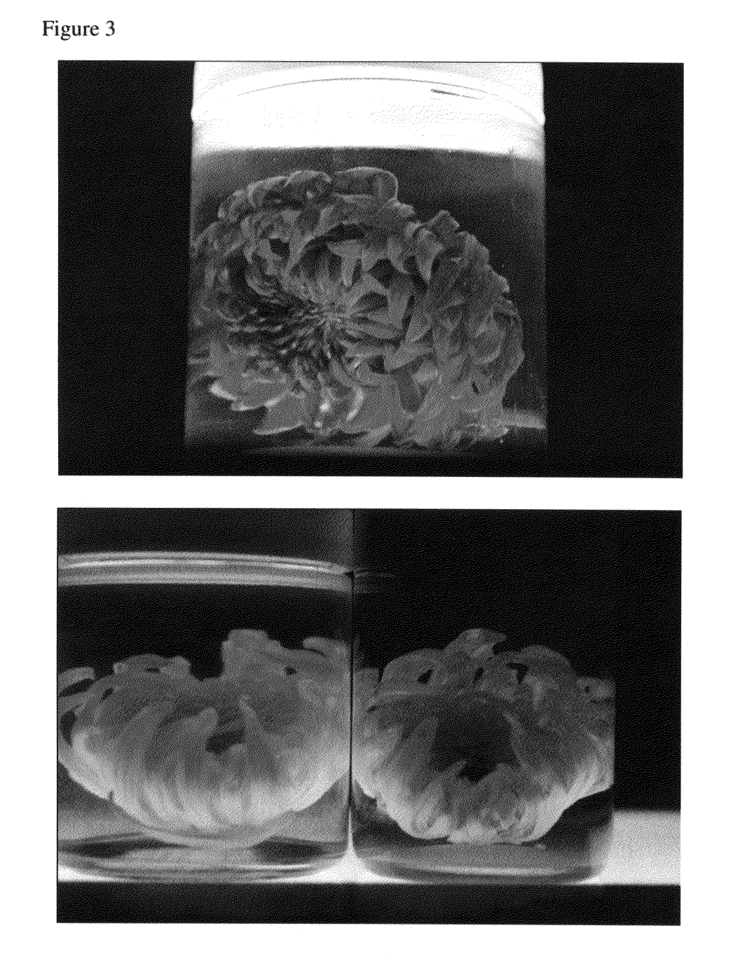

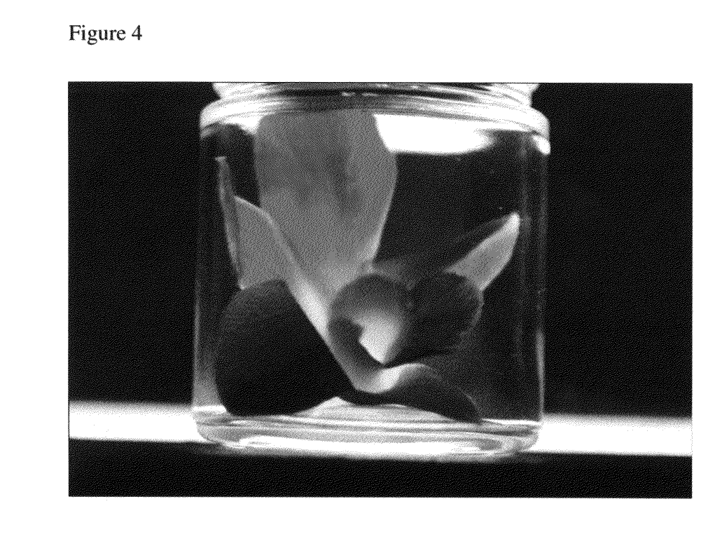

### DETAILED DESCRIPTION OF THE INVENTION

According to the containing of the preserving solution in this invention, high percentage of alcohol can dehydrate the plant immediately, terminating the enzyme activity of the plant, and preventing the nucleophilic attack from water molecule to anthocyanin. Appropriate amount of acidic material added can establish an acidic environment, which is equal to the coloring environment as the anthocyanin of the plant cell with said preserving solution. The main function of the ingredient, thiourea, is played as a role to prevent the pigment coming out of the plant, but the mechanism is unknown till now. Besides, the preserving method of this invention is very easy, improving the drawback of complex preserving method shown in the prior art. Replacing the preserving solution is also very easy, and everybody can do this at home.

The selection and ratio of the alcohol of this invention was decided by continuous testing. The alcohol used in US patent (case number 4272571, 5227205) was 3-butanol, but failing to reach good preserving effect after being added to said preserving solution of our invention. Therefore, several kinds of alcohols, including methanol, ethanol, propanol, 1-butanol, 1-pentanol, and 1-hexanol, have been tried in our invention. The result shows that 1-pentanol has the best preserving effect, and the color of flowers will fade away within 2 weeks for other kinds of alcohol.

Besides, we also found that long straight chain alcohols, such as 2-pentanol and 3-pentanol, which belong to 5 carbon alcohol, have the similar preserving effect compared to 1-pentanol. In our invention, 90% or above 1-pentanol accompanied with some isopropanol leads to best preserving effects.

As we can see from the experiment results, we assume that not only the dehydration feature of alcohols benefits the preserving effect, but also the non-polar long chain structure of alcohols, which have a hydrophobic interaction with the non-polar structure of anthocyanin, can show the inter-molecular copigmentation effect to keep the plant color near the true color, even though there is a decreasing inclination of anthocyanin. Long chain alcohols greater than 6 carbons will not be put into consideration, because the hexanol has bad preserving effect after being heated, and moreover, hexanol is solid state in room temperature, which does not meet the requirement of preserving plant specimens in room temperature.

The preserving solution of our invention has boric acid, which is an acid has a very unique mechanism. The mechanism of boric acid in water was shown as below:

B(OH)₃+2H₂O [symbol] [B(OH)₄]⁻+H₃O⁺

Most of acids are proton provider, while boric acid, a weak acid, will not form strong neucleophilic ion in water solution, preventing the neucleophilic attack to anthocyanin. Neucleophilic attack to anthocyanin can also be avoided by replacing the preserving solution. Boric acid can strengthen the acidity by interact with polyalcohol to form chelating agent rapidly, and this is a quick and effective way to establish the acid environment of the preserving solution.

The preserving effect will be influenced by the concentration of acidic ingredients in preserving solution. Best preserving effect can be acquired by using 0.25% boric acid in preserving experiment of dendrobium specimens, while increasing the boric acid concentration to 0.75% can get the best result for other flower species. The preserving effect can get worse if over increase the concentration of boric acid. Besides boric acid, study shows that replacing the boric acid with 0.5% tartaric acid can get a good color-preserving effect for roses.

When mixing appropriate amount of boric acid with tartaric acid in the preserving solution, we can find that the color of dendrobium specimens will get redder with increasing the ratio of tartaric acid, while the color become dark purple with no acid added, as compared to its original pink-purple color. According to the reason stated above, changing the ratio of acidic material can result in color changing of flowers. From the experiment result, we can also find that the preserving solution having mixture of tartaric acid and boric acid is good to color preserving effect for the flowers of compositae.

Thus, our invention provides a composition used for preserving plant, comprising, (a) 5 carbon alcohols, (b) at least one alcohol selected from the group consisting of 3 carbon alcohol and 4 carbon alcohol, (c) thiourea, and (d) at least one acidic material selected from the group consisting of tartaric acid and boric acid. The composition is used to preserve the color, pattern, and DNA of plants. In the preferred embodiment of this invention, the composition is used to preserve the color and the pattern of flowers. Moreover, by changing the ratio of acidic material, which is tartaric acid and boric acid, the composition of this invention can be used to change the color of flowers.

The word “5 carbon alcohol” used in this invention means alcohols having 5 carbon. In the preferred embodiment of this invention, said 5 carbon alcohol means long straight chain alcohols, comprising at least one alcohol selected from the group consisting of 1-pentanol, 2-pentanol, and 3-pentanol. In the best embodiment of this invention, the 5 carbon alcohol is 1-pentanol.

The word “3 carbon alcohol” used in this invention means alcohols having 3 carbon, comprising at least one alcohol selected from the group consisting of propanol and isopropanol. In the preferred embodiment of this invention, said 3 carbon alcohol means isopropanol.

The word “4 carbon alcohol” used in this invention means alcohols having 4 carbon, comprising at least one alcohol selected from the group consisting of 1-butanol and 3-butanol.

In the best embodiment of this invention, the composition of the invention comprising 1-pentanol, isopropanol, thiourea, and at least one acidic material selected from the group consisting of tartaric acid and boric acid.

In the composition of this invention, the ratio of ingredient “a” and “b” vary between 15:1 and 1:1. In the preferred embodiment of this invention, the ratio of ingredient “a” and “b” vary between 12:1 and 6:1. In the best embodiment of this invention, the ratio of ingredient “a” and “b” vary between 10:1 and 8:1.

This invention also provides a method for preserving plants, comprising soaking plants into the composition of this invention. This method is used to preserve the color, pattern, and DNA of plants. In the preferred embodiment of this invention, said method is used to preserve the color and pattern of flowers. Besides, by changing the ratio of tartaric acid and boric acid in this invention, the method can also be used to change the color of plant flowers. In the preferred embodiment of this invention, the composition is hold in a container.

The preserving method provided in this invention can also be used in making the plant specimens or used for decoration. In addition, the preserving method can also be used to make teaching tools for biology, or preserve rare or short-blossom plant when collecting specimens in wild.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The examples below are non-limiting and are merely representative of various aspects and features of the present invention.

### EXAMPLE

This creation can be put into practice in many different ways, and not limited to the examples listed below. Those embodiments shown below merely are the representation of the characteristic and various aspects of our creation. Said embodiments are not restricted to the field of the claims in our creation.

### Example 1

### Preparation of Dendrobium Sonia

The material used in this experiment was Dendrobium sonia, a common species in Taiwan flower market.

### 1.1 Preparation of the Preserving Solution (200 ml)

Weighted 2 grams of thiourea and 0.5 grams boric acid powder, added them into a solution having a ratio of 1-pentanol:isopropano1=9:1(180 ml: 20 ml), and stirred until dissolve.

### 1.2 Flower Treating

Washed the surface of fresh dendrobium sonia with reverse osmosis water (ddH2O), and then used dry towels to dry the surface. Removed the portion below 3 cm of the flower stalk, and placed the flower into a suitable size of clean specimen bottle. Filled the specimen bottle with said prepared preserving solution and seal the bottle.

### 1.3 Evaluation of the Condition of the Soaked Specimens

When shaking the specimen bottle containing dendrobium sonia, water could be found in the preserving solution after dendrobium sonia being soaked in the preserving solution within 1 hour. Those water came from the dendrobium sonia itself, and as the preamble shown, water could lead to the degradation of anthocyanin. Therefore, by replacing the preserving solution after 12 hours and 24 hours soaking, respectively, water in the dendrobium sonia can be totally replaced with the preserving solution.

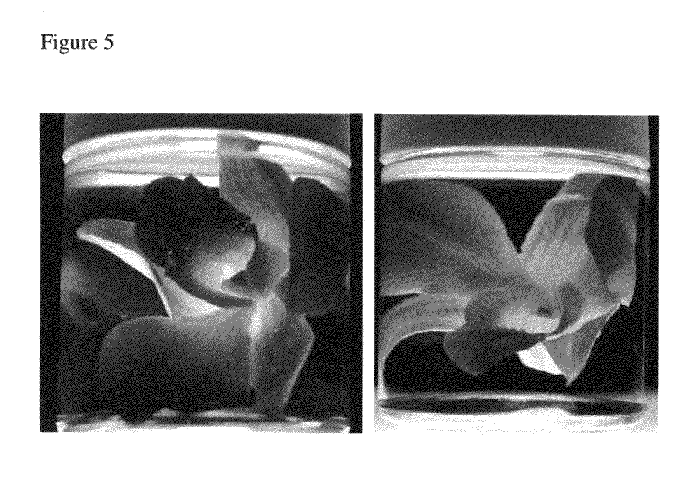

The color of dendrobium sonia got darker compared to original pink-purple color after dendrobium sonia being soaked in the preserving solution and treated for replacing process, but the changing was not significant. Dendrobium sonia became harder due to the dehydration effect, but the figure remained the same. No significant differences could be observed when compared dendrobium sonia soaked in preserving solution with the fresh and newly water soaked dendrobium sonia (FIG. 5). No pigment could be found in the preserving solution.

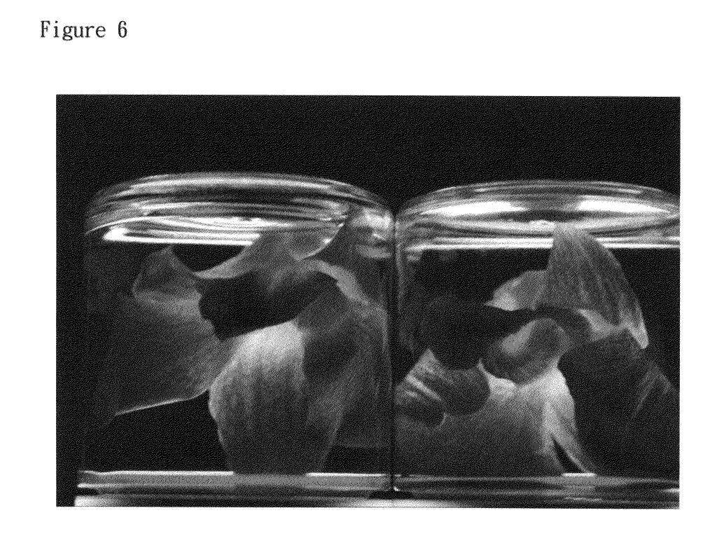

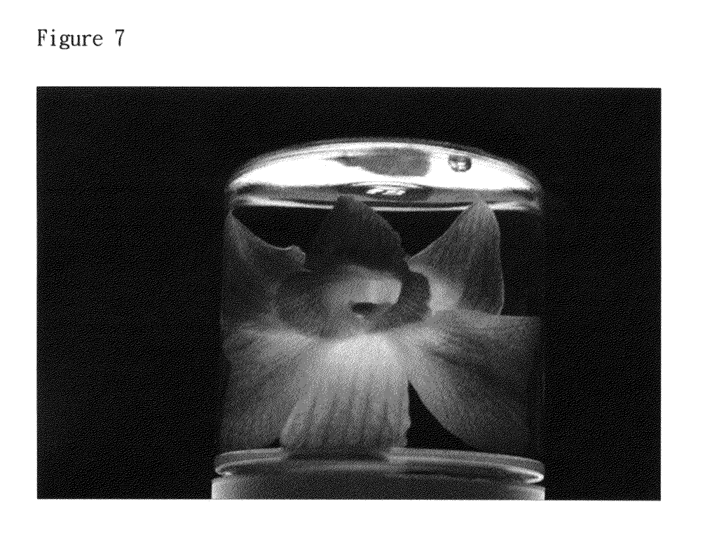

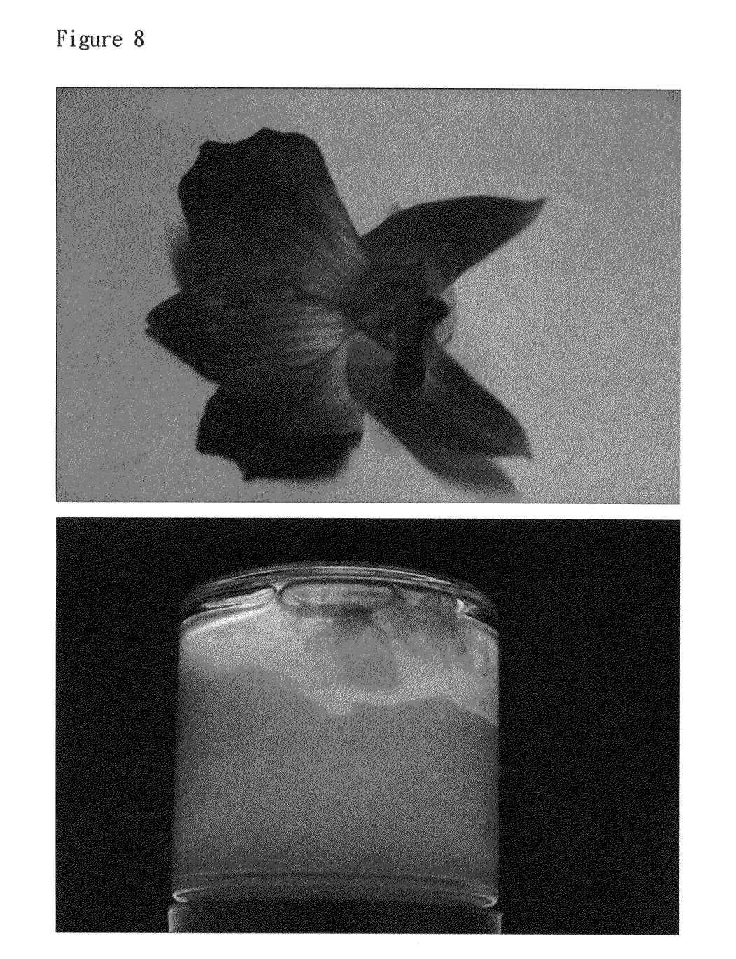

After the preserving solution replacing process completed, used Digital Single-lens reflex camera (DSLR) to record changing of the specimen at day 1, 7, 28, and 50, respectively (FIG. 6, FIG. 7). Figures and colors of the flowers stop changing under observing by eyes after the completion of replacing process, and there was a significant different in color fading and figure changing compared to those flowers soaked in water or stored in room temperature after 7 days (FIG. 8). Therefore, results showed the preserving solution had good color retaining effect to dendrobium sonia.

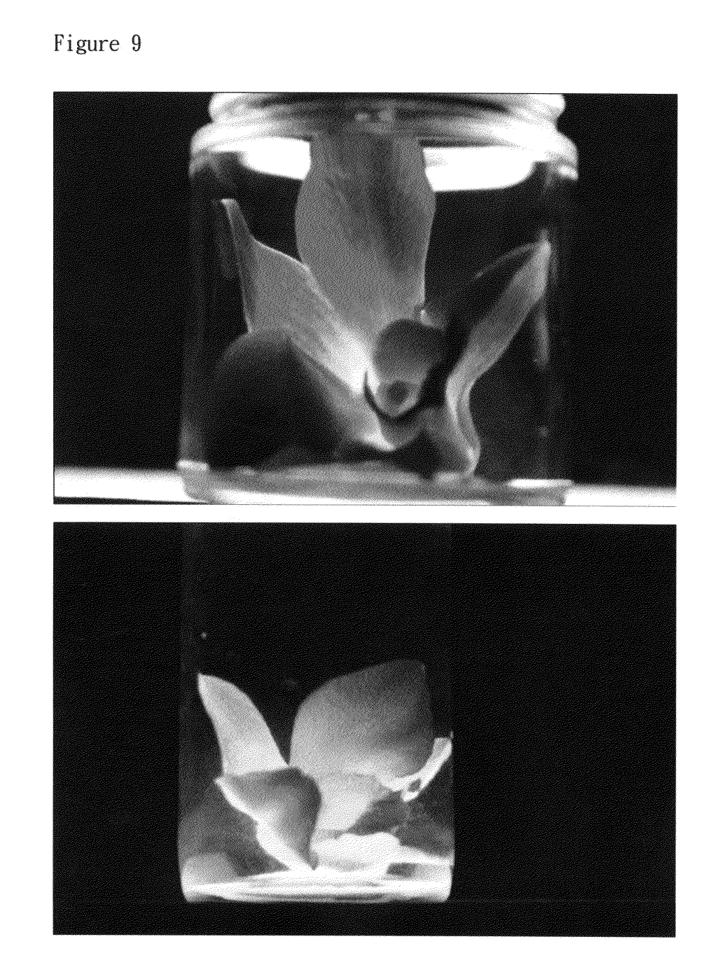

Besides to the experiment shown above, the effect of strong sun light for preserving the color of specimen has been evaluated. A set of dendrobium sonia specimen was placed 15 cm under two 20 Watts fluorescent lamps for long term exposure. Results showed that after 6 months strong exposure to fluorescent lamps (Intensity of Illumination: 70.5-71.0 μmol.m-1.s-1), the original purple color portion of dendrobium sonia changed to white as the stalk, while the middle dark purple part labellum became lighter as to the original (FIG. 9). However, further experiment should be applied to show the changing of the amount of anthocyanin.

### Example 2

### Method for Analysing Pigments of Dendrobium Sonia Specimen

### 2.1 Extraction of Anthocyanin

Took out the dendrobium sonia specimen and dried it in a vacuum pump for 3 hours; After dendrobium sonia being dried, put it into a grinder and grinded the petals into powders. Prepared the extract solution, methanol:water:acetic acid=4:5:1, and then mixed the powders with extract solution into a beaker with a ratio of 1 g powder/50 ml extract solution. Finally, extracted the anthocyanin in the flower via horizontally rotation for 3 hours by rotator.

### 2.2 pH Differential Method

pH differential method has long been a common experiment for quantify anthocyanin. By calculating the absorption value of specific wave length of anthocyanin in different pH value, other ingredients caused errors in the solution can be effectively removed, and useful data can be obtained.

### I. Reagent:

### (a) pH 1.0 Buffer Solution (KCl 0.025M):

Weighted 1.86 g KCl and put them into a 1 liter beaker. Dissolved the KCl with 980 ml reverse osmosis water (ddH2O), and then adjusted the pH to pH=1.0(±0.05) with HCl (ca 6.3 ml). Put the pH adjusted solution into a 1 liter serum bottle, and added reverse osmosis water to dilute the solution to 1 liter by volume.

### (b) pH 4.5 Buffer Solution (CH3COONa 0.4M):

Weighted 54.43 g CH3COONa and put them into a beaker. Dissolved the CH3COONa with 960 ml reverse osmosis water (ddH2O), and then adjusted the pH to pH=4.5(±0.05) with HCl (ca 20 ml). Put the pH adjusted solution into a 1 liter serum bottle, and added reverse osmosis water to dilute the solution to 1 liter by volume.

### II. Preparation of Testing Solution:

(a) Diluted 5 ml anthocyanin extract solution with pH1.0 buffer solution to 10 times (dilution factor, DF=10) to 50 ml by total volume.

(b) Diluted 5 ml anthocyanin extract solution with pH4.5 buffer solution to 10 times to 50 ml by total volume.

### III. UV-Vis Spectrometry

Used Hitachi U-2800 spectrometer to do a full wave length scan to testing solution (a) & (b), and recorded the absorption value at wave length 520 nm and 700 nm).

### IV. Calculating Method

$$Pigment of anthocyanin ( Equal value of cyaniding \text{-} 3 \text{-} 7 \text{-} {3}^{′} \text{-} triglucoside , mg \text{/} L ) = \frac{A \times MW \times DF \times {10}^{3}}{ɛ \times 1}$$

A=(A520 nm-A 700 nm) pH 1.0-(A520 nm-A700 nm) pH 4.5
MW (molecular weight)=773.55 (molecular weight of cyaniding-3-7-3′-triglucoside)
DF (Dilution Factor)=10
ε (Extinction coefficient)=12300 L×cm-1×mol-1 (Extinction coefficient of cyaniding-3-7-3′-triglucoside)
1=route length (cm)

### 2.3 High Performance Liquid Chromatography (HPLC)

C-18 column (VERCOPAK 14795 N5 ODS(C18)-4.6×250 mm) was used for analyses in room temperature in this experiment. 1.5% phosphoric acid was used as solvent A; 1.5% phosphoric acid, 20% acetic acid, and 25% acetonitrile was used as solvent B. During the separation process, the ratio of solvent B was increased in gradient from 20% to 85% within 40 minutes by the elute speed of 0.7 ml/min.

The amount of each injection was 10 μl, and the detecting wave length for the detector (Water 2796 Biosepa- rations Module) was 530 nm.

### 2.4 Quantitative and Qualitative Results of Anthocyanin

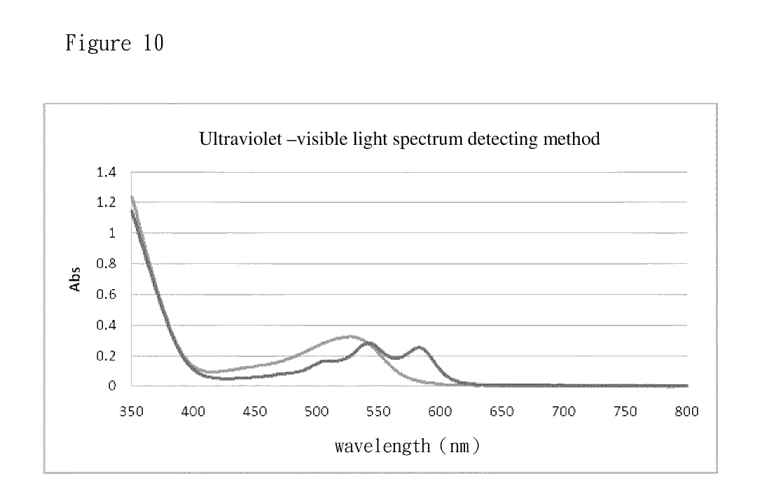

Dendrobium sonia which had been placed in dark place at room temperature for 1, 7, 14, 28 and 90 days were taken out to do the anthocyanin extraction experiment. In the UV-Vis spectrometry, the main peak showed up at 530 nm when the pH was 1, while there were 3 peaks showed up between 500 nm to 600 nm when the pH was 4.5 (FIG. 10). Calculating by the pH differential method for the dendrobium sonia specimens stored for 1 day and 7 days, the amount of anthocyanin of each gram of dendrobium sonia specimens had decreased from average 127.75 μg to 88.21 μg, and were further down to 59.57 μg for the specimen stored for 14 days; However, the degree of decreasing was significant lower for 14 days specimen (Table 1).

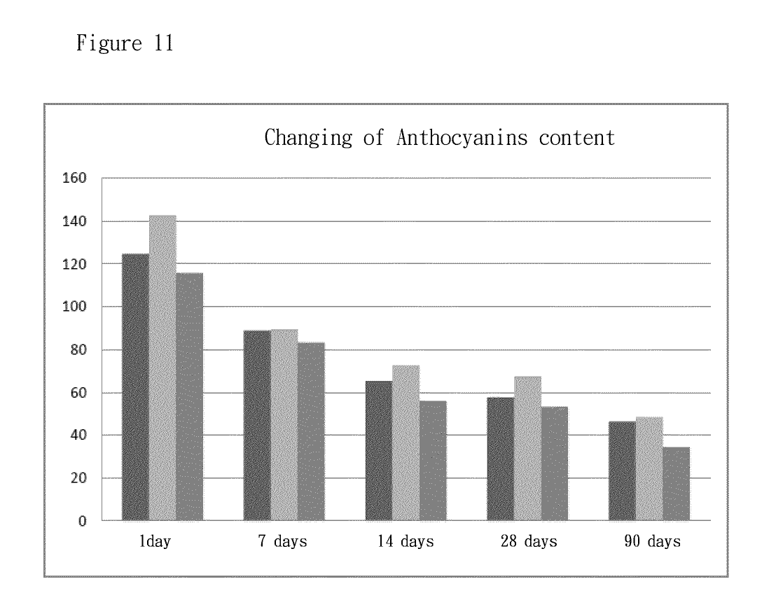

The amount of anthocyanin of the specimens stored for 28 days and 90 days almost remained the same as the specimen stored for 14 days. It could be assumed by the fact that the amount of anthocyanin would be in a steady state after the specimen being soaked in the preserving solution for 14 days (FIG. 11).

TABLE 1
Influence of soaking time to the amount of anthocyanin (mg/L)

Time(day)

| Sample | 1 | 7 | 14 | 28 | 90 |
|---|---|---|---|---|---|
| O₁ | 124.774 | 88.802 | 65.406 | 57.670 | 46.476 |
| O₂ | 142.887 | 89.556 | 72.764 | 67.669 | 48.454 |
| O₃ | 115.592 | 83.267 | 56.098 | 53.394 | 34.348 |

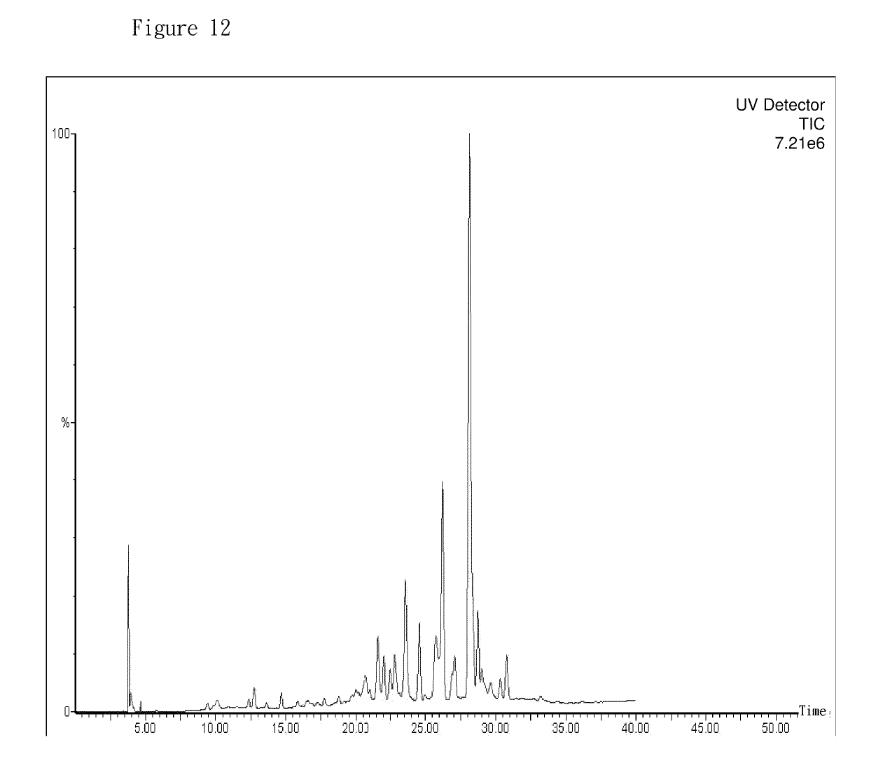

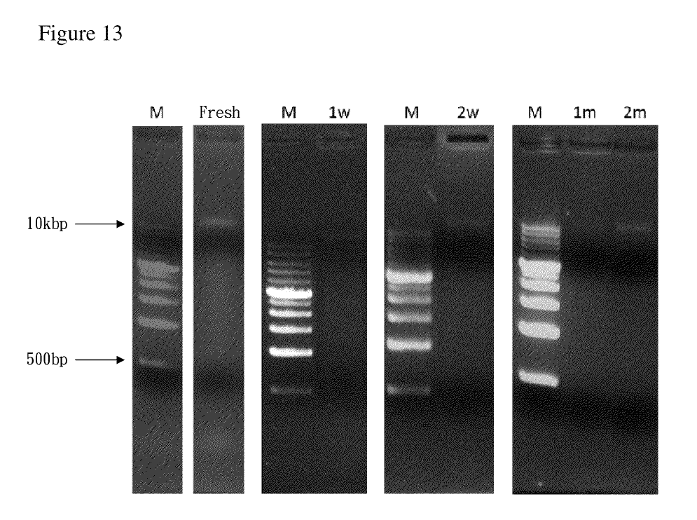

The qualitative HPLC experiment which the sample was taken from the anthocyanin extract experiment, showed that the composition of pigments in dendrobium sonia might be very complex, and the peak cyaniding-3-7-3′-triglucoside had not yet been identified. It was believed that the peak showed at 28 minutes had the greatest possibility, but further study should be applied to prove it (FIG. 12).

Quantified anthocyanin based on the experiment result of HPLC, and it could be found that the amount of anthocyanin changed by the time. There was a significant decreasing for the amount of anthocyanin within the first 2 weeks from the beginning of the experiment, and the amount of anthocyanin tended to a steady state afterward. Those results were the same as pH differential method (Table 2).

TABLE 2
Quantitative result of HPLC for anthocyanin
of dendrobium sonia specimens

| | Absorbance (530 nm) | Concentration (mg/L) |
|---|---|---|
| Standard | 133 × 10⁸ | 1000 |
| 1 day sample | 7.97 × 10⁶ | 59.924 |
| 7 day sample | 7.21 × 10⁶ | 54.210 |
| 14 day sample | 4.61 × 10⁶ | 34.662 |
| 28 day sample | 4.25 × 10⁶ | 31.955 |
| 90 day sample | 4.07 × 10⁶ | 30.602 |

### Example 3

### Analysis for the DNA Preserving Effect of Dendrobium Sonia Specimens

A kind of leaf of dendrobium sonia was used as material in DNA extraction experiment and polymerase chain reaction (PCR).

3.1 Preserving Analysis for the genome GNA of the Leaf of Dendrobium Sonia Specimens.

Took out the leaves of dendrobium sonia soaked for 1 day, 1 week, 1 month, 2 months and 3 months from the specimen bottle. Dried the preserving solution off the surface of leaves with vacuum pump, and then proceed to genome DNA extraction experiment. Observed the DNA preserving condition by electrophoresis.

3.2 Genome DNA Extraction of Dendrobium Sonia Leaf (S. H. Lim, C. F. Liew, C. N. Lim, Y. H. Lee and C. J. Goh. A simple and efficient method of DNA isolation from orchid species and hybrids. Biologia Plantarum 41 (2): 313-316, 1997.)

First of all, took 1 g fresh dendrobium sonia leaf and washed the surface of the leaf with 10(v/v) sodium hypochlorite for 10 minutes. Rinsed the leaf with reverse osmosis water (ddH2O) for 5 times, and then grinded the leaf to powders in a grinder with liquid nitrogen added. 0.6 cm-3 of polyvinylpolypyrrolidone as known as PVPP (100 mg cm-3) was added afterward. A 6 cm3 of extraction buffer (100 mM Tris-HCl, pH8.0-50 mM EDTA, pH8.0 500 mM NaCl, and 100 mM mercapto ethanol) was added to the grinder to be grinded with the powders together. At last, 0.4 cm3 of 20% sodium dodecyl sulphate (SDS) were mixed with other materials in the grinder and those mixtures were placed into centrifuge tubes.

Treated centrifuge tubes contained extraction material with 65° C. water bath for 10 minutes. Added 5M potassium acetate (pH5.2) which was ten times of extracts by volumn into centrifuge tubes, and then treated centrifuge tubes with ice bath for 20 minutes. Used high-speed centrifuge (Hitachi High-speed Refrigerated Centrifuge himac CR22G2) to centrifugate in 4° C.-10000 g for 20 minutes. Took out the supernatant and added 4 cm3 of isopropanol to precipitate DNA. Placed the supernatant in a −80° C. refrigerator for 20 minutes to accelerate the precipitation rate. Took out the supernatant from refrigerator and centrifuged in 4° C., 10000 g for 15 minutes to obtain the precipitation. Afterward, dissolved the precipitation with 2 cm3 TE buffer solution (10 mM Tris (hydroxymethyl) aminomethane- Hydrochloric acid, 1 mM Ethylene Diamine Tetraacetic Acid, pH=8.0) to form a mixture, and then added 1 mm3 of Ribonuclease A (10 mg cm3) and treated the mixture with 37° C. water bath for 30 minutes.

After treated with water bath, the mixture was added with 2 cm3 extracting solution which had a ratio of phenol:chloroform=1:1 to do the extracting process, and centrifuged in low temperature and high speed for 5 minutes to remove the water. Repeated the process stated above twice. Afterward, 3M Sodium acetate (pH5.2) which had ten times of mix solution by volume and 100% alcohol which had two and a half of mix solution by volume were added to the mix solution. The mix solution was placed in a −80° C. refrigerator for 30 minutes, and centrifuged in low temperature and high speed for 10 minutes to obtain DNA precipitation. Washed the precipitation with 70% alcohol and dried it quickly. Dissolved the precipitation with 0.5 cm3 of TE buffer solution, and stored it under 4° C. in refrigerator.

### 3.3 Preserving Experiment of Plant Naked Genome DNA of Dendrobium Sonia Leaf

Took 50₁a 1 genome DNA extracted according to the method mentioned above and added it with 500 μl of 100% alcohol to form a mixture. Placed the mixture under −20° C. in refrigerator for 2 hours to precipitate DNA. Centrifuged the mixture with high-speed centrifugation (14000 rpm, 20 minutes), dropped the supernatant and kept the precipitated DNA.

Added 50 μl of preserving solution (1-pentanol 90%, isopropanol 10%, thiourea 1%, and boric acid 0.25%) to the precipitated DNA and placed them in a dark, room temperature place for 1 week, 2 weeks, 1 month, and 2 months, respectively. After that, took them out and added 500 μl of 100% alcohol and placed them under −20° C. in a refrigerator for 2 hours to precipitate DNA. Centrifuged with high-speed centrifugation (14000 rpm, 20 minutes), dropped the supernatant liquid and added TE buffer solution to dissolve DNA, and used electrophoresis to observe DNA.

### 3.4 Polymerase Chain Reaction (PCR)

Took out the dendrobium sonia leaf specimens soaked for different time to extract DNA, and then used this DNA samples to do PCR experiment.

The system used in the PCR experiment of this invention was a system which used programs to control the temperature of heat recycle (Master cycler 5333, Eppendorf), and the polymerase is 0.4 unit Taq DNA polymerase (MO273S, BioLabs inc.). The primer sequence used was shown as SEQ ID NO:1 and SEQ ID NO:2, and the insertion position was EU430384; the reaction product was 852 bp.

### 3.5 Preserving Effect of Soaked Naked Genome DNA

The experiment result will be influenced due to the seriously interference by impurities during DNA extraction of flowers. Therefore, fresh dendrobium sonia leaf was selected as the material of DNA extraction experiment.

After the leaf DNA was extracted, mixed the extracts with preserving solution and stored it in a dark, room temperature place. Took out the extracts after storing for 1 week, 2 weeks, 1 month, and 2 months. Used DNA electrophoresis to observe if DNA was degraded. The experiment results showed that two bands could be found in the wells of electrophoresis gel and in the position greater than 10 kbp, and the result was the same as using fresh dendrobium sonia. It could be found that the naked genome DNA would not degrade if directly contact the preserving solution(FIG. 13).

### 3.6 Analysis of Preserving Effect of Dendrobium Sonia Leaf Specimen

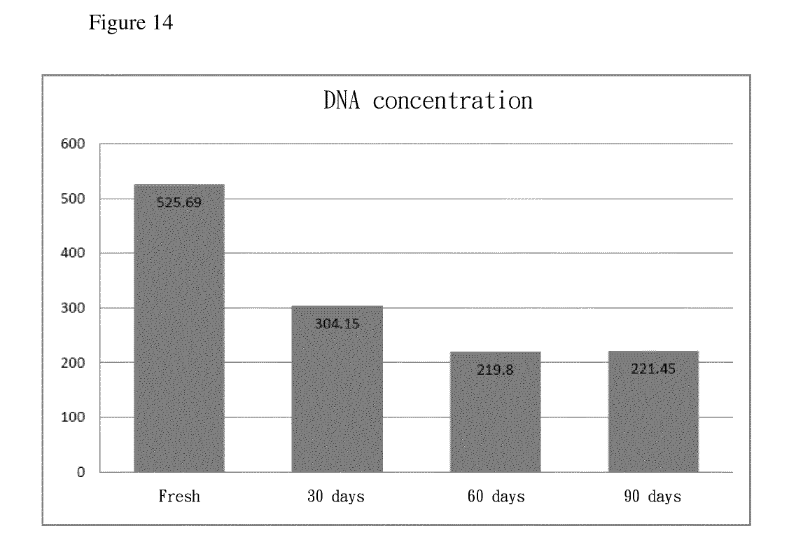

Soaked the dendrobium sonia leaf in the preserving solution and took out those leaves to extract DNA after storing for 30, 60, and 90 days, respectively. Quantified the DNA of the extract sample by using Nanodrop, and compared the results with the extracts of fresh dendrobium sonia leaf. The experiment result showed, after soaking in the preserving solution for 30 days, the amount of dendrobium sonia DNA decreased to 60% as the fresh dendrobium sonia sample, but not showed a linear decrease when extending the preserving time. The amount of DNA had no significant differences between the sample extracts of 60 and 90 days (FIG. 14).

### 3.7 DNA Electrophoresis Results of Leaf Specimen.

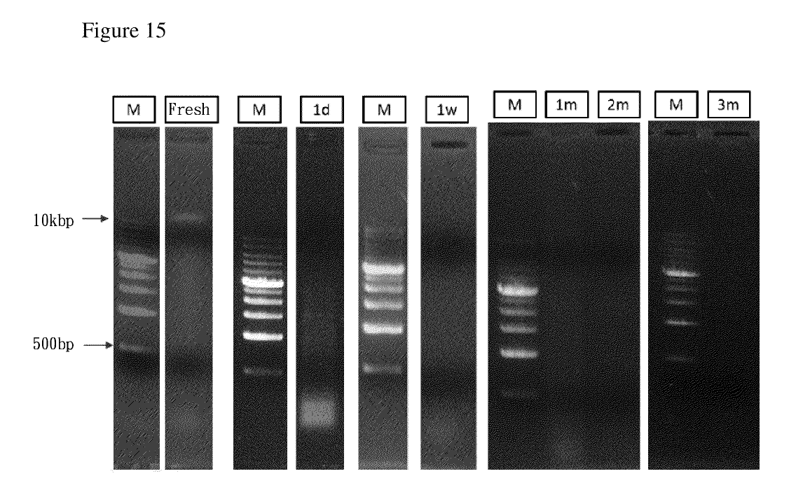

Evaluated the preserving condition of genome DNA of specimen by extracting the DNA of dendrobium sonia specimen and analysed the DNA by electrophoresis. The experiment result showed DNA smearing after the sample soaked for a day. Compared to the marker, most of the broken DNA showed at molecular weight lower than 500 bp, and the results of electrophoresis was the same for preserving for other time (FIG. 15).

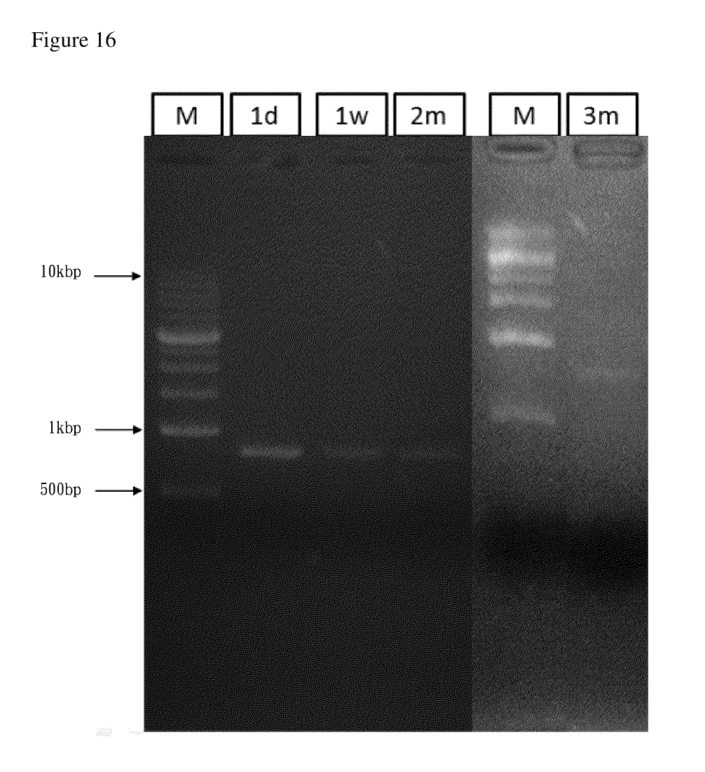

Used genes of several data bases to design primer, and ran a PCR for DNA samples extracted from every single time period. The gene of this experiment (18S ribosomal RNA gene of Dendrobium kingianum subsp. Carnarvonense) could be effectively amplified, showing very clear experiment results. After samples of every time periods being amplified by PCR, the band of electrophoresis diagram was single and clear. (FIG. 16)

### Example 4

### Preparation of Soaked Specimens of Grand Gala

### 4.1 Experiment Materials

The rose “grand gala” was purchased from ordinary flower shop, and the rose was cultured by the flower plantation in middle and south Taiwan.

### 4.2 Preparation of Rose Preserving Solution

Well mixed 90% 1-pentanol, 10% isopropanol, 1% thiourea, and 0.5% tartaric acid in room temperature, and stirred until all the solutes totally dissolved to prepare the preserving solution.

### 4.3 Preparation Method of Flower Specimen:

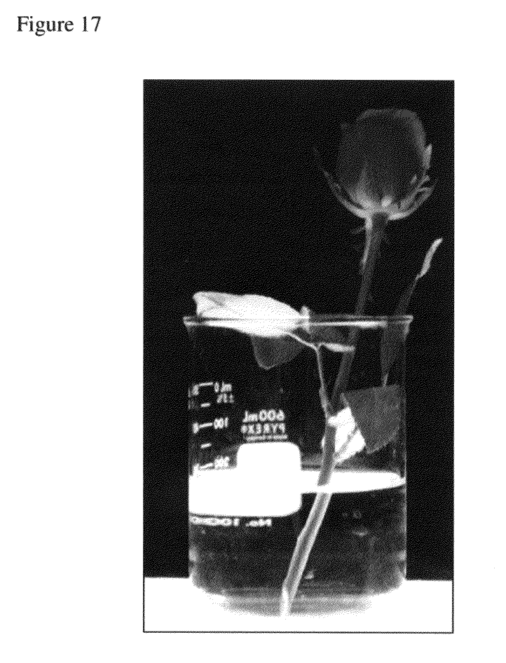

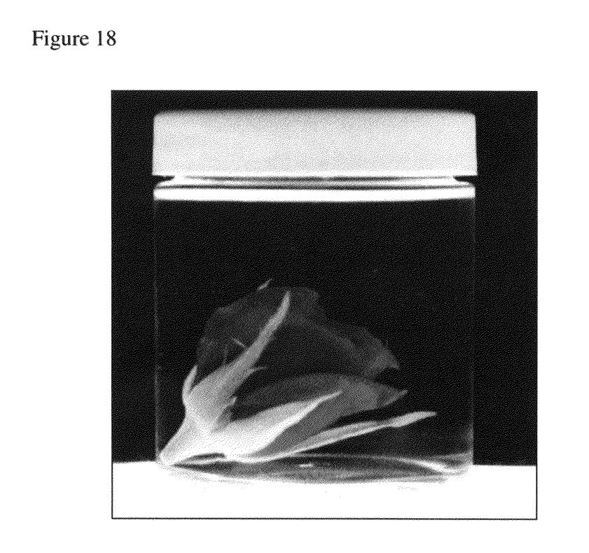

(a) Soaked the stem of fresh grand gala to the prepared rose preserving solution (FIG. 17).
(b) Chamfered the stem under the surface of preserving solution and let the stem absorb preserving solution in room temperature for 12 hours.
(c) Removed the green stems and leaves of grand gala which absorbs preserving solution, and then soaked the remaining corolla and sepal of whole flower into a glass specimen bottle which filled with preserving solution.
(d) Replaced the preserving solution every 12, 24, and 72 hours.
(e) The soaked grand gala specimen was done after replacing the preserving solution at 72 hours.

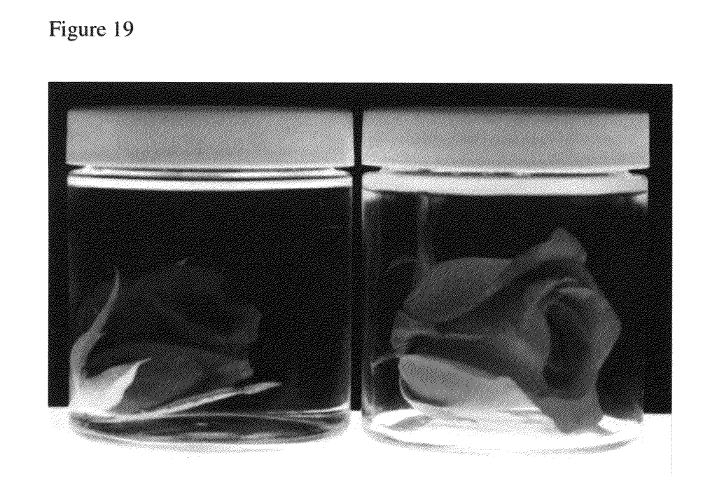

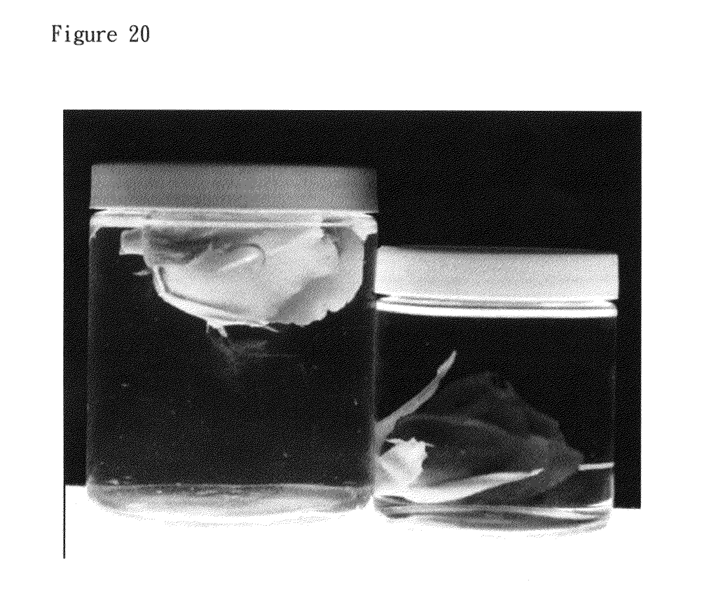

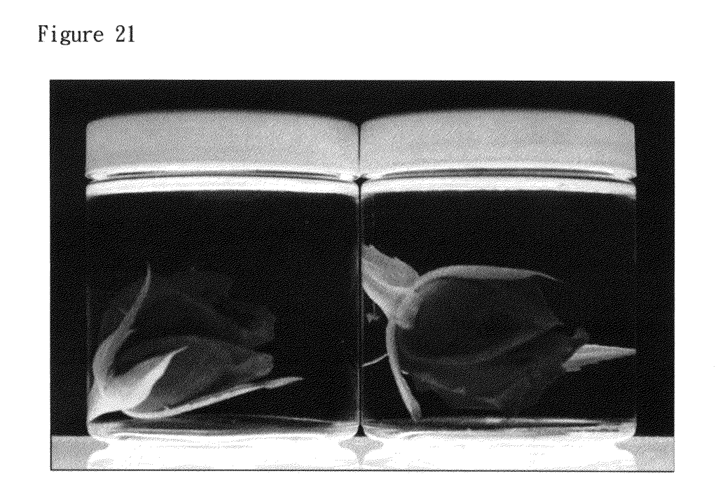

When compared the preserved grand gala with the fresh one, it could be seem that the petal color of the grand gala which soaked in the preserving solution had the same color as the fresh one. Both of them looked cardinal but the color was darker in the preserved grand gala (FIG. 19, 20). As to the appearance, the rose preserving solution dehydrated the flower because of the main composition of the preserving solution was alcohol. Although the appearance and figure almost remained the same, the petal shrunk and hardened lightly. Due to soaking in the preserving solution for a long time, the original green sepal discolored and not able to be preserved with cardinal color, even though the preserving solution can preserve the color of petal. The experiment also compared the preserving effect for preserved rose in light and dark place (FIG. 21). Placed the rose soaked in the preserving solution 15 centimeters under a pair of 20 W fluorescent lamp for 6 months (the illuminance is 70.5-71.0 μmol.m-1.s-1) consecutively, while another set of soaked rose was placed in a dark cabinet. After 6 months, took out both sets of rose to make a comparison. It can be seem that the color of both of the rose petals were almost all the same, and which means the color fading of petals did not influenced by light. However, the green part of sepal had fewer green color fading when stored in the dark place.

### Example 5

### Separation, Purification, and Qualification for Anthocyanin of Grand Gala

### 5.1 Experiment Material

(a) The way to prepare the grand gala petal which soaked in rose preserving solution was the same as described before. Only 2 grams of petals would be taken to be soaked into different glass bottles separately.
(b) Citric acid 5%, pH=1.79

### 5.2 Experiment Method

### I. Extracts of Anthocyanin

(a) Took out the grand gala petals which soaked in the rose preserving solution from the specimen bottles at different time point (1, 2, 3, 6, 12 weeks).
(b) Put the petals into pumping cylinders, dried the petals by using degas pump.
(c) Took the dried petals 0.5 grams and put them into 15 ml centrifuge tube.
(d) Milled the petals in the tube into powders by glass rod and added 15 ml citric acid solution into the tube.
(e) Well mixed the petal powders with the citric acid solution and put the mixture in water bath in 47° C. for 4 hours.
(f) After water bath, filtered the mixture with a filter (90 mm) to obtain extracts of anthocyanin.

Added 9 ml pH1.0 buffer (KCl, 0.025M) and pH 4.5 buffer (Sodium acetate, 0.4M) to 1 ml rose anthocyanin extracts, respectively, to form 2 cups of 10 ml dilution solution. After mixing well, detected the absorption value at 520 nm and 700 nm under spectrophotometer (HITACHI-2800 Double beam spectrophotometer) to obtain value Al (pH1.0) and A2 (pH4.5), value B1 (pH1.0) and B2 (pH4.5), respectively. Calculated the amount of anthocyanin from rose anthocyanin extracts by the calculating formula as follows:

$$\frac{\{ ( A 1 - B 1 ) - ( A 2 - B 2 ) \} \times MW \times F \times {10}^{3}}{ɛ}$$

MW: Molecule of anthocyanin (anthocyanin-based 3,5-bisglucoside) molecular weight=611.55 g/mol
F: Dilution factor=10
ε: Molecular absorption parameter of anthocyanin-based 3,5-bisglucoside (26300L×cm-1×mol-1)

### II. Qualification of Anthocyanin:

After filtering the anthocyanin extracts with 0.22 μm filter, analysed the filtrate with high performance liquid chromatographer (Waters 2796 Bioseparations Module). Qualified the anthocyanin by comparing the analytes with anthocyanin standard (anthocyanin-based 3,5-bisglucoside methanol solution:water=1:3).

### The Analytical Condition

C18 separation column (VERCOPAK, 14795 N5 ODS(C18), 4.6×250 mm) was used in room temperature in this experiment.

In this experiment, solution A comprised 1.5% phosphoric acid, and solution B comprised 1.5% phosphoric acid, 20% acetic acid, and 25% acetonitrile. In the separation process, the ratio of solution B was lifted from 20% to 85% within 40 minutes by gradient, and the flowing rate was 0.7 ml/min. The amount of every sample injection was 10 μl, and the detecting wave length of the detector was set at 530 nm.

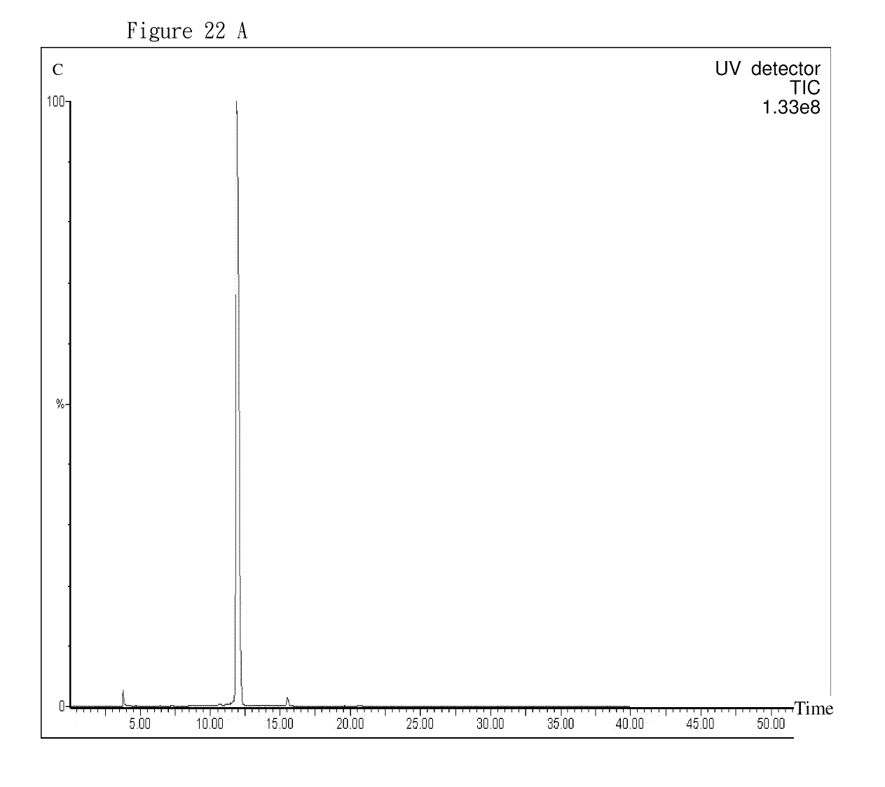

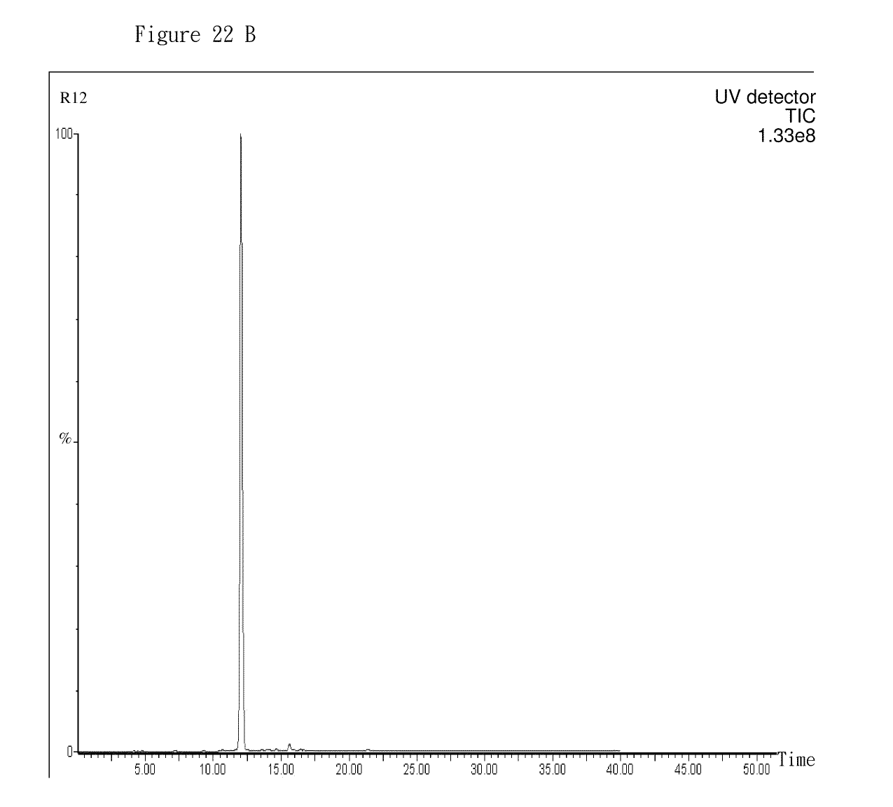

The results of this experiment showed that there was only one kind of anthocyanin in grand gala rose (FIG. 22). Used rose anthocyanin standard (anthocyanin-based 3,5-bisglucoside) to compare with the analyte, and the result showed that the anthocyanin of analyte was anthocyanin-based 3,5-bisglucoside. The result can be verified by the identical situation and time for the detected peaks of analyte and the anthocyanin standard. The value shown on right upper corner of FIG. 22 was the absorption value at 530 nm, and the amount of anthocyanin can be known by calculating said value. Compared the long-soaking time rose specimens (12 weeks) with the short-soaking time specimens (1 week), the absorption value was lower for the long-soaking ones (Table 3), and this result showed that the amount of anthocyanin went down by the increasing of soaking time. The result of calculating the amount of pigment by pH differentiation method also met said conclusion.

TABLE 3
Calculation of anthocyanin concentration and absorption value at
530 nm of standard and the rose extracted at different time point

| | Absorption | Calculation of | Estimation of pH |
|---|---|---|---|
| | value at | actual content | differentiation |
| | 530 nm | (mg/L) | (mg/L) |
| Standard | 1.33 × 108 | 1000 | |
| (anthocyanin-based | | | |
| 3,5-bisglucoside) | | | |
| 1 week soaking | 1.23 × 108 | 924.81 | 484.236 |
| sample | | | |
| 2 weeks soaking | 1.02 × 108 | 766.92 | 325.496 |
| sample | | | |
| 3 weeks soaking | 9.66 × 107 | 726.32 | 306.787 |
| sample | | | |
| 6 weeks soaking | 8.82 × 107 | 663.16 | 269.756 |
| sample | | | |
| 12 weeks soaking | 8.18 × 107 | 615.04 | 208.69 |
| sample | | | |

5.3 Changing of the Amount of Anthocyanin of Grand Gala after Soaking in the Preserving Solution

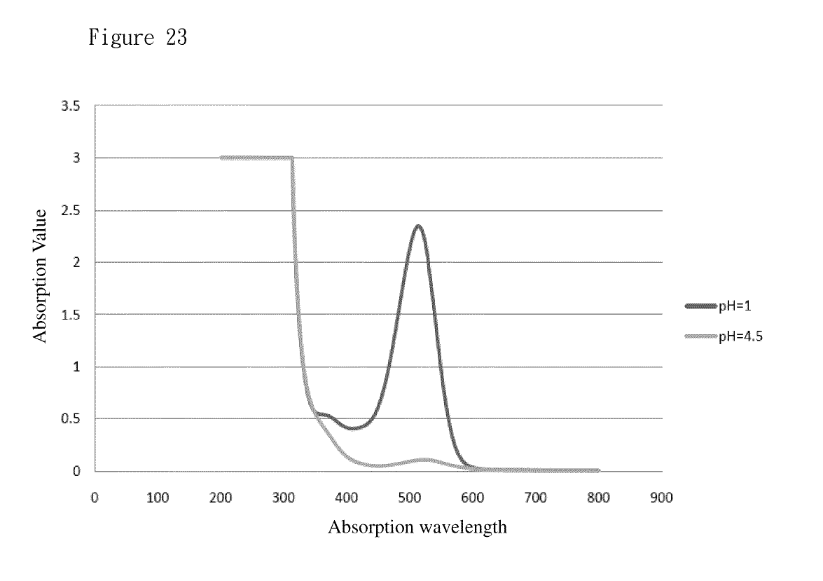

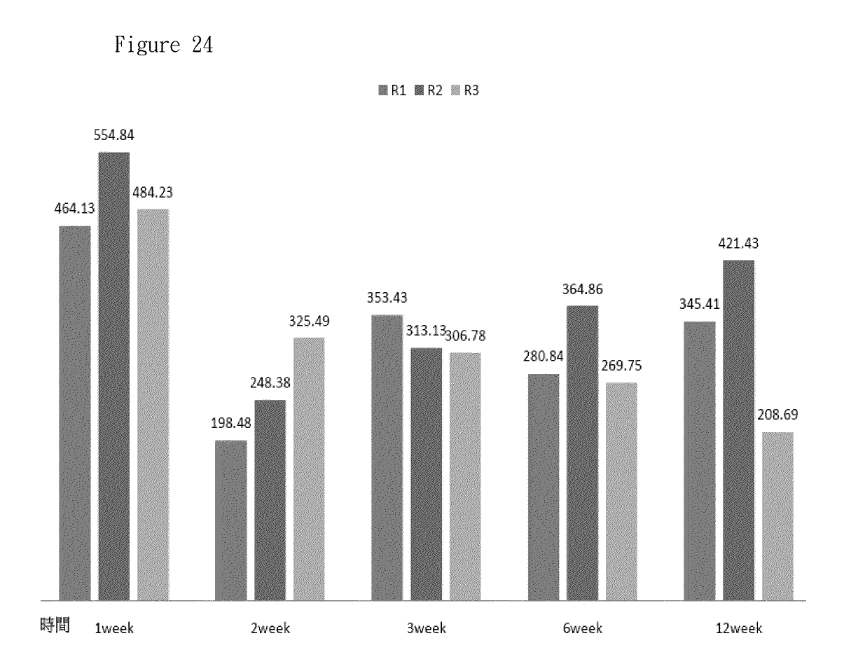

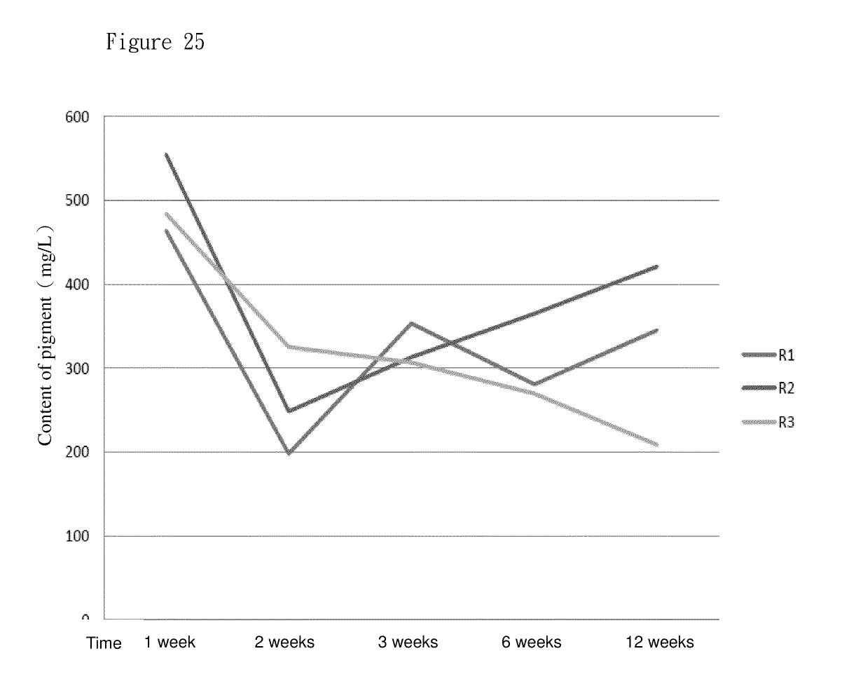

Repeated the experiment method (5.2 experiment method I) to prepare 3 sets of rose sample (shown in R1, R2, R3). After obtaining the anthocyanin from 3 sets of sample, quantified the anthocyanin by pH differentiation method. One of the samples was quantified the amount of anthocyanin by pH differentiation method. FIG. 23 was a figure of the absorption value detecting by spectrophotometer (HITACHI U-2800 Double beam spectrophotometer) in acid and base environment, respectively. Compare the changing of the amount of anthocyanin in different time point afterward. (Table 4, FIG. 24, FIG. 25)

It can be seen from the Table and Figure that the amount of anthocyanin in the rose samples varied a lot except sample R3, which the amount of anthocyanin degraded in a steady rate by the time. With increasing the storing time, the amount of anthocyanin decreased in all samples when compared to the original condition. Although the sample R3 showed a trend of decreasing in anthocyanin, the decreasing rate slowed down eventually.

TABLE 4
The amount of anthocyanin (mg/L) extracted at different
time point for 3 sets of rose sample (R1, R2, R3)

| | 1 week | 2 weeks | 3 weeks | 6 weeks | 12 weeks |
|---|---|---|---|---|---|
| R1 | 464.132 | 198.482 | 353.433 | 280.848 | 345.41 |
| R2 | 554.843 | 248.381 | 313.132 | 364.86 | 421.43 |
| R3 | 484.236 | 325.496 | 306.787 | 269.756 | 208.69 |

### Example 6

### Extract and Preserve of Grand Gala Rose Genome DNA

### 6.1 Experiment Material

Used fresh rose leaf or grand gala fresh leaf which soaked in the preserving solution, and the way to preserve the leaf was the same as described before. Only 2 grams of green leaf part was taken to be soaked in different glass specimen bottle, respectively.

### 6.2 Experiment Method

### I. Extract of Rose Leaf Genome DNA

(a.1) Took out the grand gala leaf soaked in the preserving solution from specimen bottle at different time point (1, 2, 3, 6, 9, and 13 weeks), and dried the leaf with vacuum pump.
(a.2) Weighted about 0.1 gram of dried rose leaf or fresh leaf and sterilized the surface of them with 10% (v/v) sodium hypochlorite for 10 minutes. Afterward, rinsed the sterilized samples with distilled water for 5 times.
(b) Put the leaf into a grinder and grinded the leaf into powder along with liquid nitrogen.
(c) Added 60 μl Cross-linked polyvinylpyrrolidone (100 mg/cm3) into the grinder.
(d) Added 600 μl extracts (100 mM Tris-HCl, pH8.0 50 mM EDTA, pH8.0 500 mM NaCl, and 200 mM mercapto ethanol).
(e) After transferring the extracts in the grinder to the centrifuge tube, added 40 μl 20% Sodium dodecyl sulfate to the centrifuge tube and shaked it until well-mixed. Put the well-mixed tube in 65° C. water bath for 10 minutes.
(f) Added 5M Potassium acetate (pH5.2) which was one tenth of total volume into the tube and buried it in the ice for 20 minutes.
(g) Centrifuged the tube (10000 g, 20 minutes, 4° C.).
(h) Collected the supernatant and added 400 μl isopropanol to precipitate the DNA after the centrifugation.
(i) After placing at −20° C. for 1 hour or −80° C. for 15 minutes, centrifuged (10000 g, 15 minutes, 4° C.) the mixture of supernatant and isopropanol to collect DNA.
(j) Slowly poured out the liquid in the centrifuge tube and added 200 μl TE buffer (10 mM Tris-HCl and 1 mM EDTA, pH8.0) to dissolve the precipitated DNA, and then added 1 μl Ribonuclease A (10 mg cm3).
(k) After water bathing in 37° C. for 30 minutes, added 200 μl phenol:chloroform=1:1 and centrifuged this mixture (10000 g, 5 minutes, 4° C.).
(l) After centrifugation, collect the water supernatant and added 200 μl phenol:chloroform=1:1 to repeat the step (k), (1).
(m) Mixed the supernatant collected in step (1) with 3M sodium acetate (pH 5.2, one tenth by volume) and 100% alcohol (2.5 times of total volume), and then placed the mixture in −80° C. for 30 minutes.
(n) After centrifugation (10000 g, 10 minutes, 4° C.) slowly poured out the liquid in the tube, and then added 70% alcohol to wash out the impurities. Use an oven to dry the remaining.
(o) 25 μl TE buffer solution was added to dissolve DNA to obtain the plant genome DNA.

Directly observed the genome DNA by DNA electrophoresis (southern blotting). Designed DNA primer to do the polymerase chain reaction (PCR), and then observing the PCR product by the DNA electrophoresis.

The system used in this PCR experiment was heat recycle temperature programmable system (Master cycler 5333), and the polymerase used was 0.4 unit Taq DNA polymerase (BioLabs MO273S). The DNA primer used was shown as SEQ ID NO: 3 and SEQ ID NO4.

### II. Rose Leaf Genome DNA Preserving Experiment:

(1) According to the rose leaf genome DNA extract method, took out fresh rose leaf which was not soaked in the preserving solution to extract the genome DNA. Added 600 μl 100% methanol into 40 μl of the extracts and placed them in −20° C. for 2 hours to precipitate DNA.
(2) Centrifuged (14000 rpm for 20 minutes) and removed the supernatant.
(3) Added 40 μl rose preserving solution (1-pentanol 90%, isopropanol 10%, thiourea 1%, tartaric acid 0.5%) and another tartaric acid free preserving solution (1-pentanol 90%, isopropanol 10%, thiourea 1%), respectively.
(4) Preserved the rose genome DNA in the room temperature, respectively, and took out them in different time point.
(5) 600 μl 100% methanol was added to the preserved rose genome DNA, and the mixture was placed in −20° C. for 2 hours to precipitate DNA.
(6) Centrifugation (14000 rpm for 20 minutes) and removed the supernatant.
(7) Added TE buffer solution to dissolve DNA, and separate DNA by DNA electrophoresis.

### 6.3 Grand Gala DNA Preserving Effect of Rose Preserving Solution:

### I. DNA of the Interior Organization of Plants:

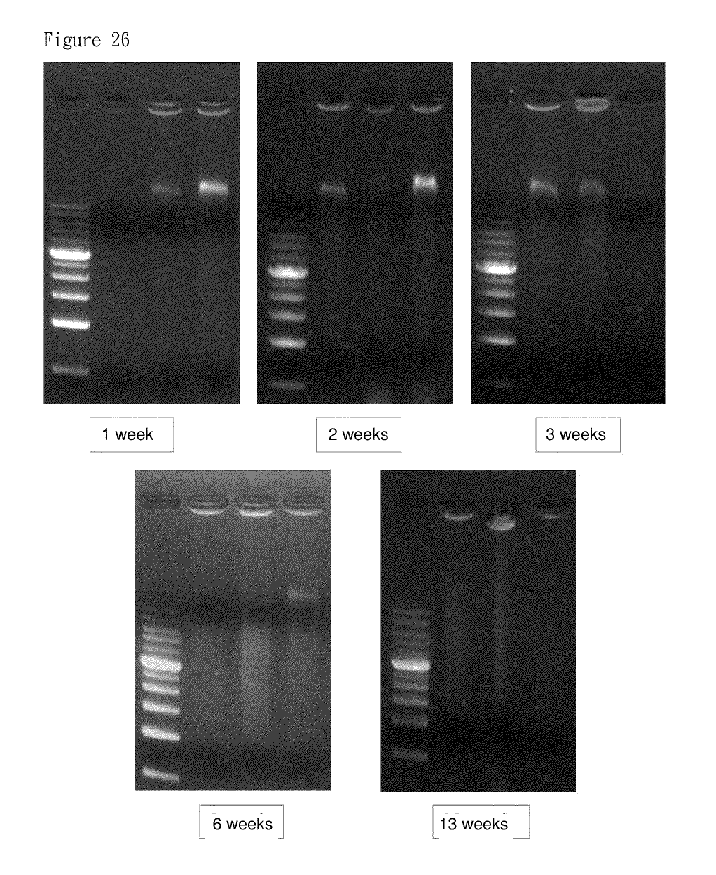

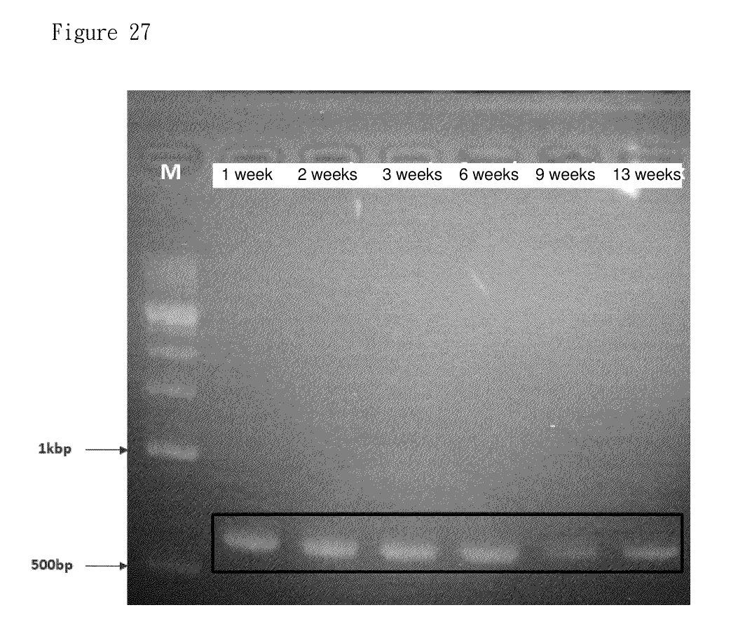

Repeated previous experiment method (6.2 experiment method I) to extract DNA of the rose soaked in the preserving solution. 3 sets of DNA sample were obtained (represented in R1, R2, R3). Observed the preserving effect of rose preserving solution to the interior leaf organization DNA by DNA electrophoresis and PCR. It can also be observed if the preserving solution will damage the DNA of the interior leaf organization by the extension of preserving time. (FIGS. 26, 27)

Band of leaf genome DNA extracted in different time point could be observed under DNA electrophoresis (FIG. 26), and all the target amplified gene fragment in different time point (1 to 13 weeks) could also be observed from the consecutive PCR experiment (took any one of the samples to do the PCR). It was indirectly proven from the fact shown above that the leaf DNA in the organism would not be damaged by the rose preserving solution, and even though some of the fragments broke into pieces, the target gene can still be amplified by PCR.

### II. Exterior Naked DNA of Plant

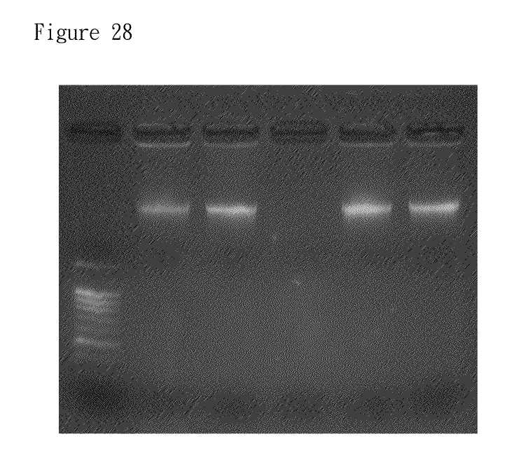

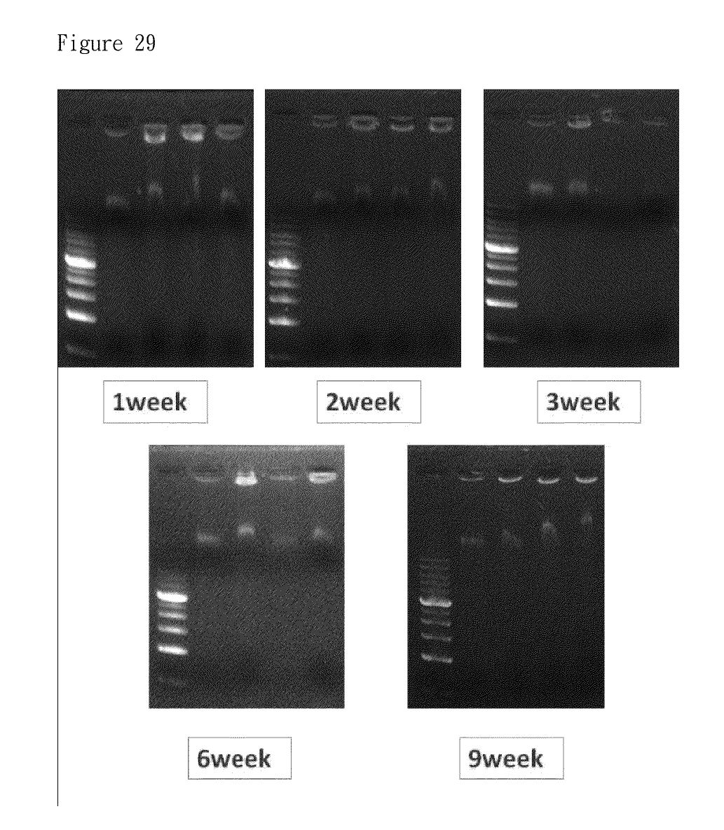

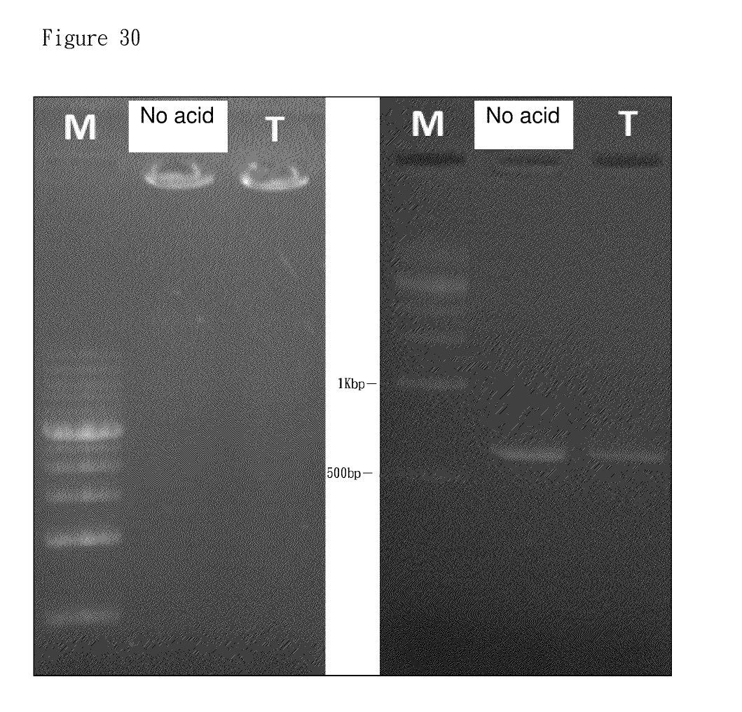

(1) Extracted the leaf genome DNA of fresh grand gala rose (by the experiment process 6.2 I), and then treated the extracts by experiment process 6.2 II. In order to evaluate the DNA preserving effect of different kinds of preserving solutions, soaked the extracted rose genome DNA in 4 different preserving solutions for 5 days (FIG. 5). The band of DNA could not be found only if soaked in preserving solution 2, and this showed that the naked DNA could be damaged when directly soaked in the preserving solution with tartaric acid (FIG. 28).
(2) 3 sets of genome DNA extracted from different roses (shown in R1, R2, and R3) were soaked in the rose preserving solution without tartaric acid, and being preserved in the room temperature for 1, 2, 3, 6, and 9 weeks, respectively. Used the DNA electrophoresis to evaluate the previous sample to see if the preserving solution having an influence on the naked DNA preserved in this preserving solution by the time increasing. (FIG. 29). The result showed that the DNA will not be damaged when being preserved in the preserving solution without tartaric acid.
(3) Soaked the naked DNA in the preserving solution with (shown in “T”) and without (shown in “no acid”) tartaric acid for one day, respectively. Used DNA electrophoresis to evaluate if the naked DNA had been damaged, and did the PCR analysis to see if specific gene still can be amplified (FIG. 30). It can be seen from FIG. 30 that even though DNA band could be observed when doing the whole genome DNA electrophoresis directly, the DNA band was not that clear for the group of preserving solution without tartaric acid. However, when doing the PCR analysis, gene amplification can be clearly observed for both groups. The result showed that even though the preserving solution with tartaric acid might damage the DNA, the condition was not that serious, and the target gene still can be amplified.

FIG. 5
4 different kinds of preserving solution
being used for preserving naked DNA

| | |
|---|---|
| Preserving | 1-pentanol 90%, isopropanol 10%, thiourea 1%, boric acid 1% |
| solution 1 | |
| Preserving | 1-pentanol 90%, isopropanol 10%, thiourea 1%, |
| solution 2 | tartaric acid 0.5% |
| Preserving | 1-pentanol 90%, isopropanol 10%, thiourea 1% |
| solution 3 | |
| Preserving | 1-pentanol 90%, isopropanol 10% |
| solution 4 | |

One skilled in the art readily appreciates that the present invention is well adapted to carry out the objects and obtain the ends and advantages mentioned, as well as those inherent therein. The compounds, processes and methods for producing them are representative of preferred embodiments, and are exemplary, not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A composition for preserving plants, which comprises:
5 carbon alcohol;
at least one alcohol selected from the group consisting of 3 carbon alcohol and 4 carbon alcohol;
a thiourea; and
at least one acid selected from the group consisting of tartaric acid and boric acid.

2. The composition of claim 1, which preserves colors, patterns and DNA of plants.

3. The composition of claim 2, which preserves colors and patterns of flowers.

4. The composition of claim 3, which changes colors of flowers.

5. The composition of claim 4, which changes colors of flowers through changing the ratio between tartaric acid and boric acid in the acid.

6. The composition of claim 1, wherein 5 carbon alcohol comprises at least one pentanol selected from the group consisting of 1-pentanol, 2-pentanol and 3-pentanol.

7. The composition of claim 6, wherein 5 carbon alcohol is 1-pentanol.

8. The composition of claim 1, wherein 3 carbon alcohol comprises at least one propanol selected from the group consisting of isopropanol and 1-propanol.

9. The composition of claim 8, wherein 3 carbon alcohol is isopropanol.

10. The composition of claim 1, wherein 4 carbon alcohol comprises at least one butanol selected from the group consisting of tert-butanol and 1-butanol.

11. The composition of claim 1, which comprises pentanol, isopropanol, thiourea, and at least one acid selected from the group consisting of tartaric acid and boric acid.

12. The composition of claim 1, wherein the ratio between component a and component b is from 15:1 to 1:1.

13. The composition of claim 12, wherein the ratio between component a and component b is from 12:1 to 6:1.

14. The composition of claim 13, wherein the ratio between component a and component b is from 10:1 to 8:1.

15. A method for preserving plants, which comprises soaking the plants in the composition of claim 1.

16. The method of claim 15, which preserves colors, patterns and DNA of plants.

17. The method of claim 16, which preserves colors and patterns of flowers.

18. The method of claim 17, which changes colors of flowers.

19. The method of claim 18, which changes colors of flowers through changing the ratio between tartaric acid and boric acid in the acid of the composition.

20. The method of claim 19, wherein the composition is loaded in the container.

21. The method of claim 15, which is applied to make plant specimens or ornamental.

22. The method of claim 15, which is applied to make biology teaching tools.

23. The method of claim 15, which is applied to preserve rare plants or plants with short flowering period at the wild collection sites.
